(19) United States
(12) Patent Application Publication
(10) Pub. No.: US 2020/0359114 A1
(43) Pub. Date: Nov. 12, 2020

(54) WIRELESS SENSOR SYSTEM

(71) Applicant: Panasonic Intellectual Property Management Co., Ltd., Osaka (JP)

(72) Inventors: MANABU GOKAN, Hyogo (JP); JUNYA TANAKA, Osaka (JP); KEIKO TAKAHASHI, Osaka (JP)

(21) Appl. No.: 16/836,949

(22) Filed: Apr. 1, 2020

(30) Foreign Application Priority Data
May 9, 2019 (JP) 2019-089040
Jan. 31, 2020 (JP) 2020-014345

(51) Int. Cl. H04Q 9/00

(52) U.S. Cl. CPC H04Q 9/00; H04Q 2209/88; H04Q 2209/40

(57) ABSTRACT

A wireless sensor system capable of operating with low power and capable of perming long-distance and high-speed data transmission includes a plurality of sensor nodes acquiring prescribed measurement data and a relay spot receiving measurement data relay-transmitted among the sensor nodes and transmitting the measurement data to a given communication device (for example, a gateway) by a LPWA (Low Power Wide Area) communication. A switching operation between a reception side (Central) and a transmission side (Peripheral) is performed in an asynchronous manner among the sensor nodes performing transmission and reception of the measurement data.

### TECHNICAL FIELD

The technical field relates to a wireless sensor system transmitting data measured by sensors wirelessly.

### BACKGROUND

Currently, a disposable primary battery or a rechargeable secondary battery (for example, a button battery or the like) is used as a power supply for a wireless sensor module. It is inevitably necessary to replace the battery in the primary battery. In the secondary battery, wiring and work for charging are necessary.

In the case where the battery is used as the power supply as described above, periodic replacement work or charging work by manpower is necessary. However, it is difficult to perform the above work when the wireless sensor module is, for example, embedded in a wall or installed in a narrow gap.

Under such circumstances, energy harvesting in which power is generated by using energy generated at an installation site of the wireless sensor module or in the vicinity thereof, and the power is used as the power supply is attracting attention. The above energy includes, for example, vibration energy generated in a motor, an engine or in a bridge, waste heat energy in a plant, thermal energy of human body temperature, ambient light of the sun/lighting and the like.

When the power generated from energy is used as described above, the wireless sensor module independent in energy can be realized, and the maintenance is not necessary for a long time or semipermanently. Moreover, such wireless sensor module can be easily installed in machines that have been already installed and infrastructures such as railways and bridges easily in a retrofitted manner as the wiring is not necessary in the wireless sensor module.

As a power generation method using the energy, for example, vibration power generation, thermal power generation, light power generation and so on can be cited; however, generated power is low in all methods. Therefore, it is required to suppress power consumption in wireless communication systems using the wireless sensor module.

Accordingly, as a technique for realizing both low power consumption supplied by the energy harvesting and a wide communication area, for example, utilization of an LPWA (Low Power Wide Area) network and relay communication among terminals by relay terminals are under consideration.

For example, in Japanese Patent No. 6322315 (Patent Literature 1), a communication system allowing efficient long distance transmission of data from a sensor device by the LPWA network is disclosed.

Here, an outline of the communication system in Patent literature 1 will be explained with reference to FIG. 7. FIG. 7 is a schematic view showing a network configuration of the communication system of Patent Literature 1.

The communication system of Patent Literature 1 includes slave units 102 as communication terminals receiving data from wireless sensor devices 103, a master unit 100 as a communication terminal controlling the slave units 102, and repeaters 101 relaying data transmission between the slave units 102 and the master unit 100. The master unit 100 is connected to a cloud server 106 through a gateway 105 and an internet line.

The slave unit 102 includes a data processing unit 104 performing prescribed data processing. The data processing unit 104 executes a long-distance transmission process by LPWA (specifically, a hop process by an LPWA system) between the slave unit 102 and the master unit 100.

In an uplink data transmission, the same channel is used by virtually dividing the channel to a high-speed side and a low-speed side between the slave units 102 and the repeaters 101, between the repeaters 101 and the master unit 100, and between the slave units 102 and the master unit 100. On the other hand, in a downlink data transmission, the same channel is used in all lines between the master unit 100 and the repeaters 101 and between the repeaters 101 and the slaves 102.

The slave unit 102 compares RSSIs (received signal strength indicators) of ACKs received from the master unit 100 and the repeater 101 respectively, selecting a unit with a stronger RSSI as a destination and transmitting next data to the destination. The master unit 100 compares RSSIs of signals received from the slave unit 102 and the repeater 101 respectively, transmitting the ACK to a unit with a stronger RSSI.

As described above, in the communication system of Patent Literature 1, the long distance transmission can be realized under an environment with no direct prospect due to obstacles and so on by performing the hop process in accordance with the LPWA system. Next, a communication system allowing relay communication will be explained with reference to FIG. 8. FIG. 8 is a schematic view showing an example of a topology of BLEmesh of Bluetooth (registered trademark) Sig Core Spec Ver 5.0.

The communication system shown in FIG. 8 enables mesh-type relay transmission on a beacon base. The communication system includes low-power nodes 112 dedicated to transmission, relay nodes 111, a proxy node 110, and a host terminal 113 as shown in FIG. 8. A communication standard of this communication system is a communication standard capable of realizing short-distance (for example, approximately 10 to 50 m) data transmission with low power consumption.

However, in the communication system shown in FIG. 7, it is necessary to keep the repeaters 101 in an activated state constantly so as to receive data transmitted from any of slave units 102. Therefore, the power of the repeaters 101 is constantly on and power consumption is increased.

In the communication system shown in FIG. 8, power consumption is low, which is several mW to several dozen mW; however, it is difficult to predict the timing of data transmission in the low-power nodes 112 which are terminals dedicated to transmission. Accordingly, it is necessary to keep the relay nodes 111 in the activated state constantly. Therefore, the power of the relay nodes 111 is constantly on and power consumption is increased.

Furthermore, the communication system shown in FIG. 8 has a communication method of the beacon base; therefore, a connection time for communication requires one second at most. Accordingly, it takes a lot of time when a large amount of data is transmitted, which makes data transmission low in speed.

### SUMMARY

An object of an embodiment of the present disclosure is to provide a wireless sensor system capable of operating with low power and capable of performing long-distance and high-speed data transmission.

A wireless sensor system according to an embodiment of the present disclosure includes a plurality of sensor nodes acquiring prescribed measurement data and a relay spot receiving the measurement data relay-transmitted among the sensor nodes and transmitting the measurement data to a given communication device by an LPWA (Low Power Wide Area) communication, in which a switching operation between a reception side and a transmission side is performed in an asynchronous manner among the sensor nodes performing transmission and reception of the measurement data.

According to the present disclosure, operation can be realized with low power, and long-distance and high-speed data transmission can be performed.

### BRIEF DESCRIPTION OF THE DRAWINGS

FIG. 1A is a schematic view showing a configuration of a wireless sensor system according to an embodiment of the present disclosure;

FIG. 1B is a schematic view showing an installation position of a relay spot according to the embodiment of the present disclosure;

FIG. 2 is a schematic view showing an arrangement example of sensor nodes and the relay spot according to the embodiment of the present disclosure;

FIG. 3 is a block diagram showing a configuration of the sensor node according to the embodiment of the present disclosure;

FIG. 4 is a schematic view showing a topology of the wireless sensor system according to the embodiment of the present disclosure;

FIG. 5 is a schematic view used for explanation of a role switching operation of the sensor node according to the embodiment of the present disclosure;

FIG. 6 is a schematic view used for explanation of relay transfer of data between sensor nodes according to the embodiment of the present disclosure;

FIG. 7 is a schematic view showing a network configuration of a communication system according to Patent Literature 1; and

FIG. 8 is a schematic view showing an example of a topology of BLEmesh of Bluetooth (registered trademark) Sig Core Spec Ver 5.0.

### DESCRIPTION OF EMBODIMENT

Hereinafter, an embodiment of the present disclosure will be explained with reference to the drawings. Note that the same symbols are given to common components in respective drawings and explanation thereof is suitably omitted.

### <Wireless Sensor System 10>

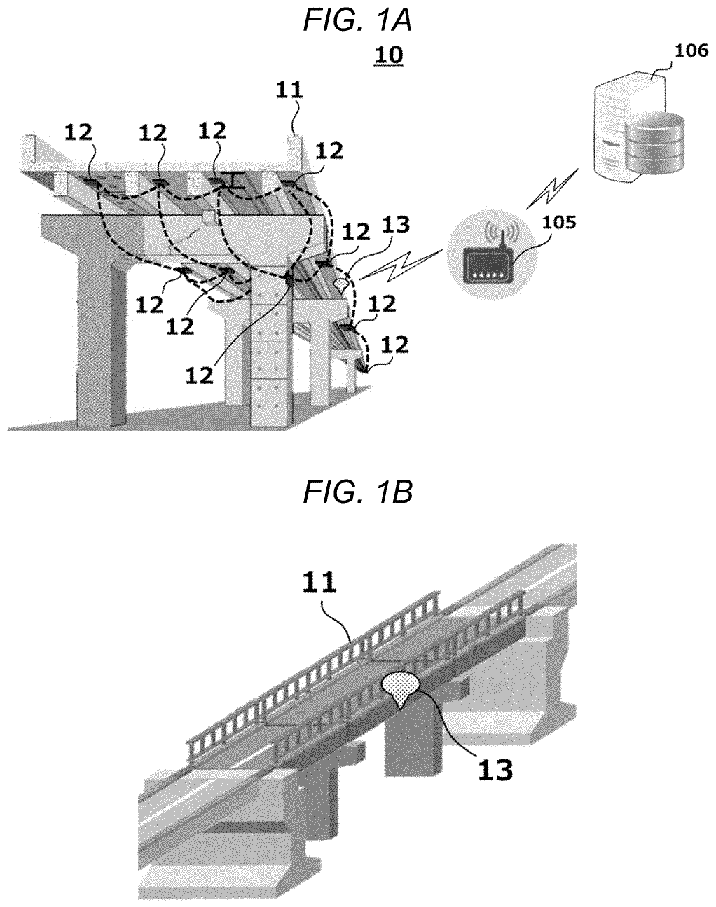

The entire configuration of a wireless sensor system 10 according to the embodiment of the present disclosure will be explained with reference to FIG. 1A and FIG. 1B. FIG. 1A is a schematic view showing the configuration of the wireless sensor system 10. FIG. 1B shows a schematic view showing an installation position of a relay spot 13.

As shown in FIG. 1A, the wireless sensor system 10 includes a plurality of sensor nodes 12, the relay spot 13, a gateway 105, and a cloud server 106.

As shown in FIG. 1A, the plural sensor nodes 12 are provided between girders of a floor slab (the back of a surface on which vehicles and so on travel) of a bridge 11. Broken lines drawn between sensor nodes 12 in FIG. 1A show that the sensor nodes 12 are wirelessly connected to one another. The plural sensor nodes 12 are not shown in FIG. 1B. As a wireless communication method used between the sensor nodes 12, for example, Bluetooth (registered trademark), ZigBee (registered trademark) and so on can be used; however, the method is not limited to them.

As shown in FIG. 1A and FIG. 1B, the relay spot 13 is provided in a halfway point in a length direction of the bridge 11.

The relay spot 13 is wirelessly connected to at least one of the plural sensor nodes 12. As a wireless communication method used between the relay spot 13 and the sensor nodes 12, for example, Bluetooth (registered trademark), ZigBee (registered trademark) and so on can be used; however, the method is not limited to them.

The relay spot 13 is wirelessly connected to the gateway 105. The gateway 105 is connected to the cloud server 106 through the internet line. As a wireless communication method used between the relay spot 13 and the gateway 105, for example, LoRa, Sigfox and so on can be used; however, the method is not limited to them.

### <Arrangement of Sensor Nodes 12, Relay Spot 13>

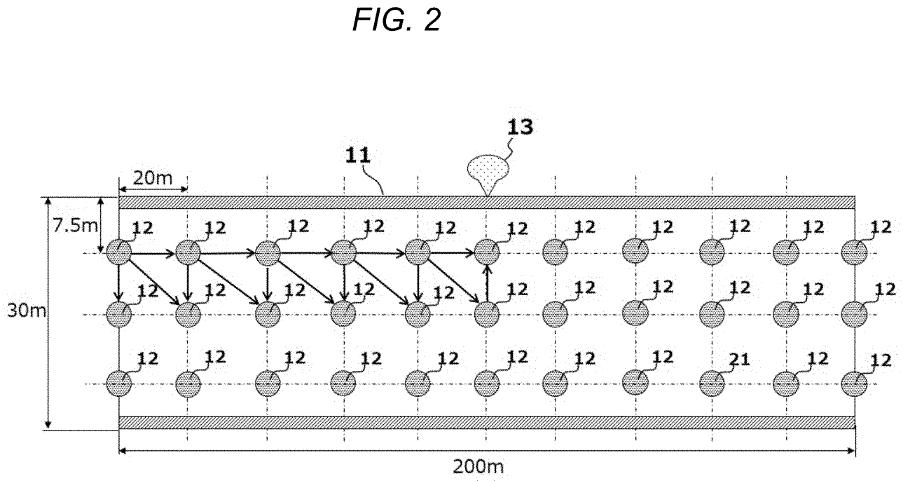

Here, an arrangement example of the sensor nodes 12 and the relay spot 13 in the bridge 11 will be explained in more detail with reference to FIG. 2. FIG. 2 is a schematic view showing the arrangement example of the sensor nodes 12 and the relay spot 13 on the floor slab of the bridge 11.

As shown in FIG. 2, the bridge 11 in which the plural sensor nodes 12 are provided has 200 m in length and 30 m in width.

The sensor nodes 12 are arranged in a lattice shape on the floor slab of the bridge 11 as shown in FIG. 2. Specifically, the sensor nodes 12 are arranged at intervals of 7.5 m in a width direction of the bridge 11, and at intervals of 20 m in the length direction of the bridge 11.

Also as shown in FIG. 2, the relay spot 13 is arranged in the halfway point in the length direction of the bridge 11 on the back side (traveling surface's side of vehicles and so on) of the floor slab of the bridge 11. The number of the relay spot 13 is one.

The example in which the sensor nodes 12 are arranged in the lattice shape is shown in FIG. 2; however, the example is not limited to this. For example, the sensor nodes 12 may be arranged in zigzag. It is also preferable that the sensor nodes 12 are arranged at random, not at equal intervals in the length direction and the width direction of the bridge 11.

The example in which the relay spot 13 is arranged at the halfway point in the length direction of the bridge 11 is shown in FIG. 2; however, it is also preferable that the relay spot 13 is arranged at positions other than the halfway point. Moreover, a plurality of relay spots 13 may be arranged.

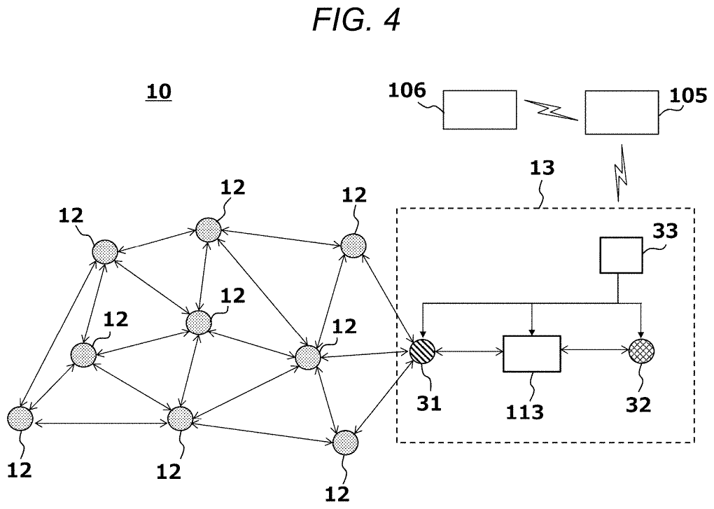

Although the explanation has been made that the sensor nodes 12 transmit measurement data to adjacent sensor nodes 12 in FIG. 2 and FIG. 4, the measurement data can be transmitted to every other sensor node 12 within a short distance.

When the sensor node 12 has measurement data, the sensor node notifies unspecified sensor nodes 12 of the possession of measurement data, not transmitting the data to specified sensor nodes 12. In a case where the sensor node 12 in a central mode is ready to receive data among the unspecified sensor nodes 12, a request signal is outputted and communication between the sensor nodes 12 is established. The sensor node 12 to which the measurement data is transmitted is determined for the first time.

### <Sensor Node 12>

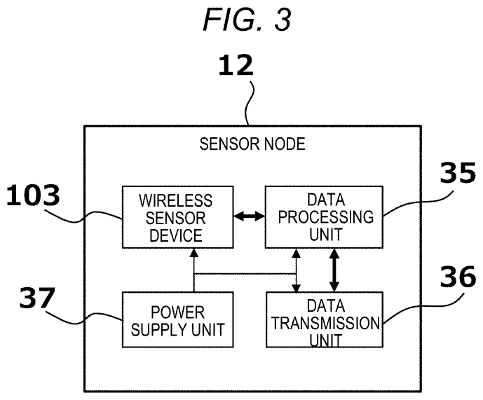

A configuration of the sensor node 12 will be explained with reference to FIG. 3. FIG. 3 is a block diagram showing the configuration of the sensor node 12.

As shown in FIG. 3, the sensor node 12 includes a wireless sensor device 103, a data processing unit 35, a data transmission unit 36, and a power supply unit 37.

The wireless sensor device 103 is a device measuring a state of the bridge 11 or the periphery thereof and performing wireless communication of data indicating a measurement result (hereinafter referred to as measurement data). As the wireless sensor device 103, for example, an acceleration sensor, a temperature sensor, a humidity sensor, a strain sensor, an air pressure sensor and so on can be cited; however, the wireless sensor device 103 is not limited to them. One kind of wireless sensor device 103 and plural kinds of wireless sensor devices 103 may be included in one sensor node 12.

The data processing unit 35 is a device controlling the operation of the wireless sensor device 103, accumulating measurement data received from the wireless sensor device 103 and converting the measurement data to a prescribed format (for example, a format in which wireless transmission can be performed).

The data processing unit 35 is formed by, for example, a CPU (Central Processing Unit), a ROM (Read Only Memory), a RAM (Random Access Memory), a D/A (Digital/Analog) converter, an A/D (Analog/Digital) converter and so on.

The data transmission unit 36 is a communication device performing transmission of measurement data. Specifically, the data transmission unit 36 receives measurement data from the wireless sensor device 103 and transmits the measurement data to another sensor node 12.

The data transmission unit 36 is formed by, for example, an antenna, a communication IC (Integrated Circuit) and so on. The data transmission unit 36 may also include an operation processor for controlling communication in addition to the antenna and the communication IC.

The power supply unit 37 is a power supply device supplying power to the wireless sensor device 103, the data processing unit 35, and the data transmission unit 36.

For example, the power supply unit 37 is formed by a vibration power generation device, a thermal power generation device, a light power generation device or the like. A device generating power by using energy generated in the bridge 11, and a primary battery (for example, a button battery, an alkaline dry battery or the like) or a secondary battery (for example, a lithium-ion battery, nickel hydrogen battery or the like) may be adopted. The power supply unit 37 may also include a power supply controller such as a DC/DC converter and an AC/DC converter.

The power supply unit 37 may also perform intelligent power management by the control of the data processing unit 35.

### <Relay Spot 13>

The relay spot 13 is a system performing the LPWA communication. For example, the relay spot 13 transmits measurement data received from plural sensor nodes 12 to the gateway 105 and controls the plural sensor nodes 12 (for example, setting of parameters and so on).

Here, a configuration of the relay spot 13 will be explained with reference to FIG. 4. FIG. 4 is a schematic view showing a topology of the wireless sensor system 10. The topology is formed by modelling a connection state of a network by points and lines.

As shown in FIG. 4, the relay spot 13 includes a master node 31, a relay terminal 32, a power supply unit 33 and a host terminal 113.

The master node 31 receives measurement data transmitted from plural sensor nodes 12 and transmits the measurement data to the host terminal 113.

The master nodes 31 also allocates individual IDs to respective sensor nodes 12. The details thereof will be described later.

The host terminal 113 is, for example, an information processor such as a personal computer. The host terminal 113 receives measurement data from the master node 31 and performing prescribed calculation. The host terminal 113 also transmits measurement data and data indicating calculation results (hereinafter referred to as calculation result data) to the relay terminal 32. As the calculation result data, for example, frequency data obtained by performing FFT (Fast Fourier Transform) calculation of data from the acceleration sensor and the like can be cited.

The relay terminal 32 is a communication device receiving measurement data and calculation result data from the host terminal 113 and transmitting the data to the gateway 105.

As a communication standard used in the relay terminal 32, LoRa standard, Sigfox standard and the like can be cited; however, the standard is not limited to them and standards complying with LPWA may be used.

The power supply unit 33 is a power supply device supplying power to the master node 31, the relay terminal 32 and the host terminal 113. The power supply unit 33 may be an adapter of AC100V when there is a power supply infrastructure, and may be components in which, for example, a solar cell, the lithium-ion battery, a lead storage battery and so on are combined when there is no power supply infrastructure.

### <Gateway 105>

The gateway 105 is a communication device executing protocol conversion of measurement data and calculation result data received from the relay spot 13 and transmitting the data to the cloud server 106 through the internet line.

### <Cloud Server 106>

The cloud server 106 is an information processor arranged on Internet. The cloud server 106 has a function of accumulating large volume data and a function of performing high-level and complicated operation processing (for example, diagnosis, analysis, learning and so on) by using the accumulated data.

For example, the cloud server 106 performs operation processing concerning preventive maintenance, life prediction and so on of the bridge 11 based on measurement data and calculation result data received from the gateway 105.

In the wireless sensor system 10 configured as described above, measurement data of the sensor nodes 12 and calculation result data of the relay spot 13 are transmitted from the relay spot 13 to the cloud server 106 on Internet through the gateway 105 by the LPWA communication.

### <Flow of Measurement Data>

Next, the flow of measurement data will be explained.

In the sensor nodes 12, measurement data acquired by the wireless sensor devices 103 is simultaneously transmitted from the data transmission units 36 to other sensor nodes 12 through the data processing units 35.

The sensor nodes 12 are switched to either role of Central or Peripheral by the data transmission units 36. In the embodiment, switching to either role of Central and Peripheral is defined as “role switching”.

Central means a role of receiving measurement data and Peripheral means a role of transmitting data. For example, when data is transmitted from the sensor to a terminal (for example, a smart phone, a tablet and the like), the role of the sensor is Peripheral and the role of the terminal is Central.

There are two kinds of measurement data transmitted from the sensor nodes 12. One data is measurement data (hereinafter referred to as a log A) acquired by the wireless sensor device 103 of the sensor node 12 itself. The other data is measurement data (hereinafter referred to as a log B) received from another sensor node 12. Both the log A and the log B may exist in one sensor node 12 depending on the status of data transmission.

As described above, the master node 31 of the relay spot 13 allocates individual IDs to respective sensor nodes 12. In the embodiment, an ID of the sensor node 12 and an ID of the log A are set into one format, which is defined as a “log identifier A”. Also in the embodiment, an ID of the sensor node 12 and an ID of the log B are set into one format, which is defined as a “log identifier B”. Moreover, the number of times the sensor node 12 transmits data to another sensor node 12 is defined as a “relay count”.

### <Role Switching Operation>

Next, the role switching operation will be explained. Here, explanation will be made by citing a case where Bluetooth Low Energy (hereinafter referred to as BLE) communication standard is adopted to the wireless sensor system 10 as an example. In the following explanation, terms defined in the BLE communication standard are not explained.

If all sensor nodes 12 are in the same role (either Central or Peripheral) by the role switching operation, the sensor nodes 12 are permanently incapable of transmitting measurement data to other sensor nodes 12.

For example, a given sensor node 12 intends to transmit measurement data acquired by the wireless sensor device 103 of itself to another sensor node 12, the role of the given sensor node 12 is Peripheral. When another sensor node 12 becomes in Peripheral at the very same timing by the role switching operation, both the given sensor node 12 and another sensor node 12 become in Peripheral; therefore, they are not capable of realizing transmission and reception of measurement data.

That is, it is necessary to any one of roles in two sensor nodes 12 becomes Central for realizing transmission and reception of measurement data between the two sensor nodes 12.

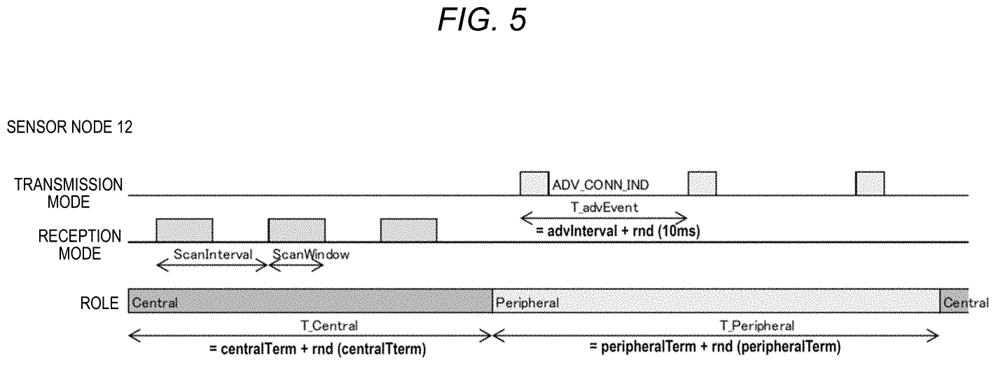

Hereinafter, the role switching operation in one sensor node 12 will be explained with reference to FIG. 5. FIG. 5 is a schematic view used for explanation of the role switching operation of one sensor node 12. In FIG. 5, a time axis advances from left to right.

The sensor node 12 is in a reception mode while the role thereof is Central. In the reception mode, the sensor node 12 waits for reception of an advertisement transmitted from another sensor node 12 within a Scan Interval cycle for a Scan Window width.

The advertisement is data for notifying the Central's side of the existence of the Peripheral's side. The advertisement is periodically transmitted.

The Scan Interval cycle is a time interval at which the Central's side receives the advertisement periodically transmitted from the Peripheral's side.

The Scan Window width is a time width during which the Central's side receives the advertisement periodically transmitted from the Peripheral's side.

The sensor node 12 is in a transmission mode while the role thereof is Peripheral. In the transmission mode, the sensor node 12 transmits the advertisement within a T_advEvent cycle, being in a state of waiting for reception until the Scan Window width of the sensor node 12 is synchronized with a Scan Window width of another sensor node 12.

The T_advEvent cycle is a time interval at which the Peripheral's side transmits the advertisement.

Here, the data transmission unit 36 of each sensor node 12 generates three parameters of T Central that is a period during which the sensor node 12 is Central, T Peripheral that is a period during which the sensor node 12 is Peripheral, and T_advEvent that is the time interval at which the advertisement is transmitted by random numbers. Accordingly, the role switching operation is executed among the sensor nodes 12 in an asynchronous manner. For example, in two sensor nodes 12 performing transmission and reception of measurement data, one of them is switched to Central and the other is switched to Peripheral. In the embodiment, time sharing processing is performed so that the reception side (Central) and the transmission side (Peripheral) are alternately switched in the asynchronous manner to avoid overlapping of transmission timing of measurement data in respective sensor nodes 12 as described above.

### <Data Transmission Operation>

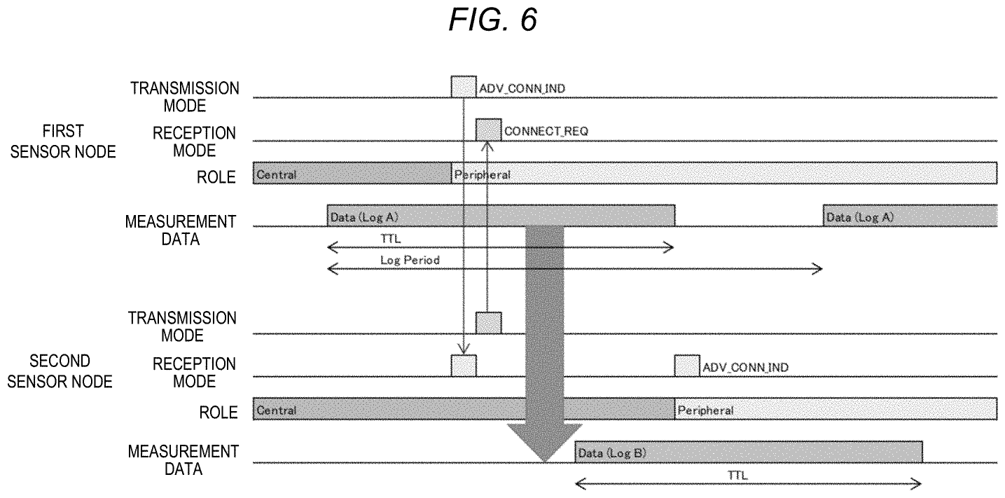

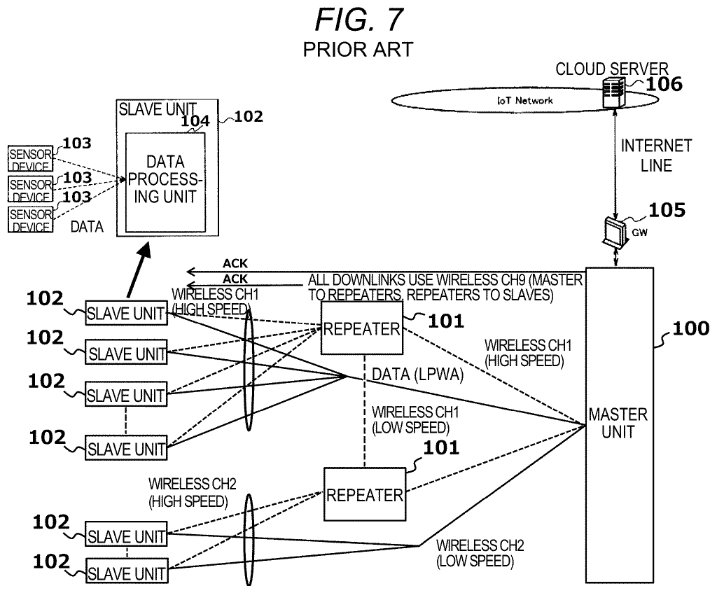

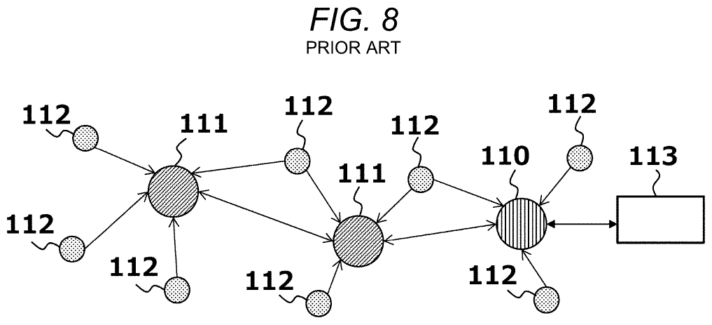

Data transmission between sensor nodes 12 performed when measurement data is newly acquired in the wireless sensor device 103 during the asynchronous role switching operation will be explained with reference to FIG. 6. FIG. 6 is a schematic view used for explanation of data transmission operation between the sensor nodes 12. In FIG. 6, the time axis advances from left to right.

In the following explanation, one of the two sensor nodes 12 is called a “first sensor node” and the other is called a “second sensor node”. Also in the following description, explanation will be made by citing a case where the first sensor node transmits measurement data newly acquired by the wireless sensor device 103 of itself (hereinafter referred to as the log A) as an example.

First, the first sensor node transmits an advertisement (ADV_CONN_ID) storing a log identifier A including an ID of the first sensor node and an ID of the log A.

Here, the log identifier A is not recorded in transfer history data stored in the second sensor node. The transfer history data is data indicating identifiers of logs which have been transferred to the second sensor node. For example, sixteen latest log identifiers are recorded at the maximum in the transfer history data.

When the second sensor node receives the advertisement (ADV_CONN_ID) from the first sensor node, the second sensor node is wirelessly connected to the first sensor node as there is no transfer history of the log A as described above, transmitting a transfer request (CONNECT_REQ) of the log A to the first sensor node.

When the first node receives the transfer request (CONNECT_REQ) of the log A from the second sensor node, the first sensor node continuously transmits the log A to the wirelessly-connected second sensor node in packet units.

The packet unit means a small group obtained by dividing data by a fixed volume of data. When a large volume of data is transmitted in a batch, a period of time during which data occupies a line is extended, and error checking and correction will be troublesome when garbled data or data missing occurs. That is, it takes time when performing retransmission for correcting an error. Accordingly, data is transmitted in packet units.

Next, when the transfer of the log A from the first sensor node to the second sensor node is completed, the second sensor node records the log identifier A in transfer history data stored in the second sensor node itself.

Here, in a case where the relay count of the log A (included in the advertisement) is 1 or more, the second sensor node transmits an advertisement storing a log identifier B including an ID of a log B to a third sensor node (not shown). Data transfer between the second sensor node and the third sensor node after that is the same as the above-described data transfer between the first sensor node and the second sensor node.

As described above, relay transmission of the log A for the first sensor node (the log B for sensor nodes other than the first sensor node) is performed among the sensor nodes.

Then, the log A for the first sensor node is finally received by the master node 31 of the relay spot 13. The relay transmission is thus completed.

Storing of the ID of the log A or the ID of the log B, and the ID of the first sensor node in the advertisement is stopped after a transmission time of data passes. Accordingly, it is possible to prevent data from being transmitted from the sensor node on the reception side to the sensor node of the transmission source.

For example, parameter setting data and command setting data (both are examples of setting data) of respective sensor nodes 12 are transmitted from the master node 31 under control of the master node 31, which are relay-transmitted between respective sensor nodes 12. In this case, an identifier of setting data is stored in a setting ID in the advertisement.

### <Advantages>

In the wireless sensor system 10 explained above, a period of time taken for relay transmission is approximately 1/40 and power consumption is approximately ½ as compared with BLEmesh on the beacon base.

Also in the wireless sensor system 10, a dedicated terminal for relay-transmitting data is not necessary; therefore, a space for installation can be effectively utilized.

As described above, the wireless sensor system 10 according to the embodiment includes a plurality of sensor nodes 12 acquiring measurement data indicating given measurement results and the relay spot 13 receiving measurement data relay-transmitted among the sensor nodes 12 and transmitting the measurement data to a given communication device (for example, the gateway 105) by the LPWA communication, in which the reception side (Central) and the transmission side (Peripheral) are switched among the sensor nodes 12 performing transmission and reception of measurement data in the asynchronous manner.

Here, when the sensor node intending to transmit data is synchronized with another sensor node at the very same switching timing between Central and Peripheral, the reception side is about to transmit data (Peripheral) even when data is desired to be transmitted (Peripheral). Therefore, data communication is not established forever. Accordingly, switching is performed in the asynchronous manner so that the switching timing is shifted to be transmission (Peripheral) and reception (Central) among the sensor nodes.

Accordingly, it is not necessary that the power supply is constantly on in each sensor node 12 in the wireless sensor system 10 according to the embodiment; therefore, the operation can be performed even from electric energy capable of being generated in energy harvesting as well as high-speed and long-distance (may be wide-range) data transmission can be realized with low power consumption. As a result, periodical replacement work or charging work necessary when using the batteries is not necessary; therefore, manpower and expenses required for these works can be reduced.

The present disclosure is not limited to the above explanation of the embodiment and various modifications may occur within a scope not departing from the gist thereof.

For example, explanation has been made by citing the case where the gateway 105 and the cloud server 106 are included in the wireless sensor system 10 as the example in the embodiment; however, the wireless sensor system 10 may have a configuration not including the gateway 105 and the cloud server 106. That is, it is sufficient that the wireless sensor system 10 has a configuration including at least the plural sensor nodes 12 and the relay spot 13.

The sensor node 12 can select a mode in which measurement data is not transmitted when measurement data of itself has a value equal to or less than a certain threshold. Also in this case, the sensor node 12 sends measurement data from another sensor node 12 if it comes. In this case, the sensor node 12 receives measurement data coming from another sensor node 12 and sends the data to further another sensor node 12. That is, the first sensor node does not send measurement data to the second sensor node when the measurement data of itself has a value equal to or less than a certain threshold.

When measurement data has a value equal to or less than a certain threshold, the measurement data has no meaning. For example, vibration is measured by a vibration sensor, measurement data is not necessary if there is almost no vibration, and it is not necessary to send the data. The amount of data can be reduced. The threshold is determined by respective sensors or the like. The threshold is not a value for eliminating noise.

The first sensor node does not send measurement data to the second sensor node when the measurement data itself has a value equal to or less than a threshold; however, the first sensor node receives measurement data from the third sensor node and sends the measurement data to the fourth sensor node.

The wireless sensor system according to the present disclosure is capable of performing high-speed and wide-range data communication with low power consumption, which is useful in IOT (Internet of Things) in which many use scenes such as in an industrial field, crime prevention and disaster prevention fields, a social infrastructure field, medical and welfare fields and so on are expected.

What is claimed is:

1. A wireless sensor system comprising:
a plurality of sensor nodes acquiring prescribed measurement data; and
a relay spot receiving the measurement data relay-transmitted among the sensor nodes and transmitting the measurement data to a given communication device by an LPWA (Low Power Wide Area) communication,
wherein a switching operation between a reception side and a transmission side is performed in an asynchronous manner among the plurality of sensor nodes performing transmission and reception of the measurement data.

2. The wireless sensor system according to claim 1,
wherein the switching operation is executed by generating a period during which the sensor node is on the reception side, a period during which the sensor node is on the transmission side, and a time interval at which the sensor node on the transmission side transmits an advertisement for notifying the sensor node on the reception side of the existence of itself to the sensor node on the reception side by random numbers.

3. The wireless sensor system according to claim 1,
wherein the sensor node on the transmission side transmits the measurement data to the sensor node on the reception side in packet units.

4. The wireless sensor system according to claim 2,
wherein the advertisement includes an identifier of the sensor node on the transmission side and an identifier of the measurement data transmitted by the sensor node on the transmission side.

5. The wireless sensor system according to claim 1,
wherein setting data of the sensor node is transmitted from the relay spot and is relay-transmitted among the sensor nodes.

6. The wireless sensor system according to claim 1,
wherein the sensor nodes are operated by using power generated by using energy generated under an environment where the sensor nodes are installed.

7. The wireless sensor system according to claim 1,
wherein a first sensor node does not transmit the measurement data to a second sensor node in a case where the measurement data has a value equal to or less than a threshold.

8. The wireless sensor system according to claim 1,
wherein the first sensor node does not transmit the measurement data to the second sensor node in the case where the measurement data has a value equal to or less than a threshold, and
the first sensor node receives the measurement data from a third sensor node and transmits the measurement data to a fourth sensor node.
